(19) United States
(12) Patent Application Publication
(10) Pub. No.: US 2026/0054563 A1
(43) Pub. Date: Feb. 26, 2026

(54) OFF-ROAD VEHICLE

(71) Applicant: KAWASAKI MOTORS, LTD., Hyogo (JP)

(72) Inventors: Jumpei TOKUDA, Akashi-shi (JP); Kouji ITOU, Akashi-shi (JP)

(73) Assignee: KAWASAKI MOTORS, LTD., Hyogo (JP)

(21) Appl. No.: 19/258,694

(22) Filed: Jul. 2, 2025

(30) Foreign Application Priority Data
Aug. 22, 2024 (JP) 2024-140644

(51) Int. Cl. B60K 11/04; B60H 1/00; B60H 1/32; B60K 5/00; B62D 25/10; B62D 25/14; B62D 25/20; B62D 33/02; B62D 33/06

(52) U.S. Cl. CPC B60K 11/04; B60H 1/00407; B60H 1/3222; B60K 5/00; B62D 25/10; B62D 25/14; B62D 25/20; B62D 33/02; B62D 33/0604; B62D 33/0617; B60H 2001/3292; B60K 2005/003

(57) ABSTRACT

An off-road vehicle includes: a dashboard that faces an occupant seat; and an air conditioning system. The air conditioning system includes: an air conditioner that is located in front of the dashboard and includes an evaporator and a blower; a condenser located in a front space; and an electric compressor located in front of the dashboard.

### CROSS-REFERENCE TO RELATED APPLICATION

This application claims priority to and the benefit of Japanese Patent Application No. 2024-140644 filed on Aug. 22, 2024, the entire disclosure of which is incorporated herein by reference.

### BACKGROUND OF THE INVENTION

### Field of the Invention

The present disclosure relates to an off-road vehicle including an air conditioning system.

### Description of the Related Art

US 2023/0311619 A1 discloses an off-road vehicle including an air conditioning system. In this vehicle, an internal combustion engine is located behind and under an occupant seat. A propeller shaft through which rotational power output from the internal combustion engine is transmitted extends in a vehicle front-rear direction. The floor panel includes a center tunnel portion which is located at a middle in a vehicle width direction and projects upward. A tunnel space in which the propeller shaft is located is defined under the center tunnel portion. An air conditioner is located in a space located in front of a cabin. A compressor is located near the internal combustion engine and is driven by the power of the internal combustion engine. A cooling medium pipe that connects the air conditioner to the compressor extends in the front-rear direction in the tunnel space.

According to the above configuration, since components of the air conditioning system are distributedly located in the vehicle front-rear direction, the air conditioning system increases in size.

### SUMMARY OF THE INVENTION

An object of one aspect of the present disclosure is to reduce the size of an air conditioning system mounted on an off-road vehicle.

An off-road vehicle according to one aspect of the present disclosure includes: a cabin in which an occupant seat is located; a front cover that defines a front space from above, the front space being located in front of the cabin; a dash panel that separates the cabin from the front space; a dashboard that is located behind the dash panel and faces the occupant seat; and an air conditioning system. The air conditioning system includes: an air conditioner that is located in front of the dashboard and includes an evaporator and a blower; a condenser located in the front space; and an electric compressor located in front of the dashboard.

### BRIEF DESCRIPTION OF THE DRAWINGS

FIG. 1 is a left side view of an off-road vehicle according to an embodiment.

FIG. 2 is a left side view of the off-road vehicle which shows pipes of an air conditioning system and the like shown in FIG. 1.

FIG. 3 is a perspective view when viewed from a rear-right side of an air conditioner and the like of the vehicle of FIG. 1.

FIG. 4 is a left side view of the off-road vehicle which shows Modified Example 1 of the position of an electric compressor.

FIG. 5 is a perspective view showing the electric compressor of FIG. 4 and a soundproof structure.

FIG. 6 is a plan view showing Modified Example 2 of the position of the electric compressor.

FIG. 7 is a schematic diagram showing the electric compressor according to Modified Example 1.

FIG. 8 is a schematic diagram showing the electric compressor according to Modified Example 2.

FIG. 9 is a left side view of the off-road vehicle which shows Modified Example 1 of the position of a radiator.

FIG. 10 is a left side view of major components of the off-road vehicle which shows Modified Example 1 of the position of a condenser.

FIG. 11 is a plan view of major components of the off-road vehicle which shows Modified Example 2 of the position of the condenser.

FIG. 12 is a left side view of the off-road vehicle which shows a modified example of the position of the compressor.

### DETAILED DESCRIPTION

Hereinafter, an embodiment will be described with reference to the drawings. Directions in the following description are based on directions of an off-road vehicle 1 unless otherwise defined individually. A vehicle front-rear direction corresponds to a vehicle length direction, and a vehicle width direction corresponds to a vehicle left-right direction.

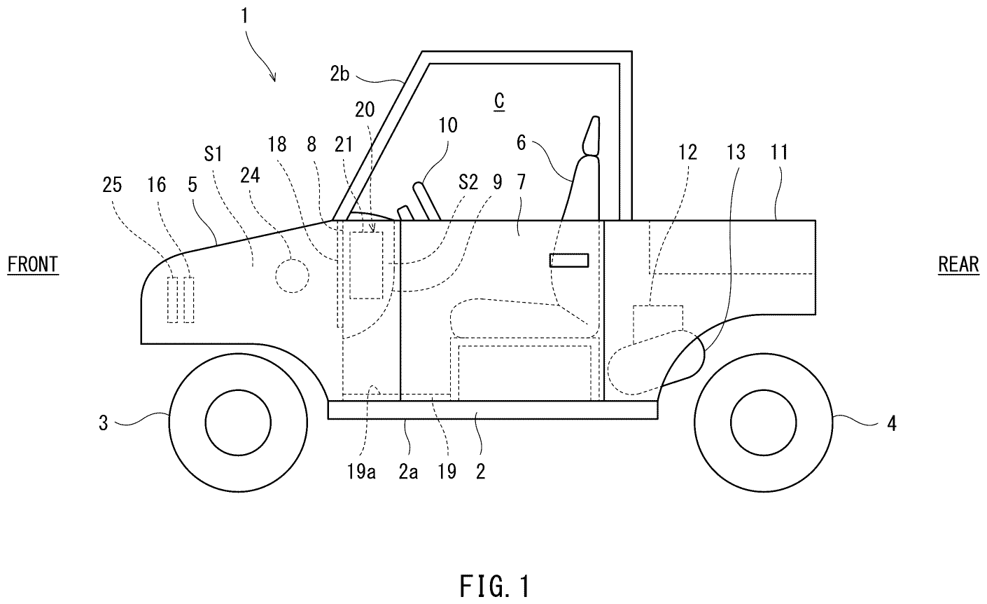

FIG. 1 is a left side view of the off-road vehicle 1 according to the embodiment. As shown in FIG. 1, the off-road vehicle 1 includes: a vehicle body frame 2; a pair of front wheels 3 that are left and right front wheels and support a front portion of the vehicle body frame 2; and a pair of rear wheels 4 that are left and right rear wheels and support a rear portion of the vehicle body frame 2. Tires for the front wheels 3 and the rear wheels 4 may be, for example, balloon tires for irregular ground traveling. The off-road vehicle 1 may also be called a utility vehicle.

The vehicle body frame 2 is a pipe frame including pipes connected to each other. The vehicle body frame 2 includes a floor frame 2a and a cabin frame 2b. The floor frame 2a supports an occupant seat 6 from below through a seat support frame. The cabin frame 2b defines a cabin C in which the occupant seat 6 is located. A floor panel 19 is located at an upper side of the floor frame 2a. The floor panel 19 defines the cabin C from below. The floor panel 19 includes a floor surface 19a located in front of and under the occupant seat 6. Feet of an occupant who sat on the occupant seat 6 are placed on the floor surface 19a of the floor panel 19.

A front cover 5 supported by the vehicle body frame 2 is located in front of the cabin C. The front cover 5 covers, from above, a front space S1 located between the left and right front wheels 3. The front cover 5 may include a front hood, a front side cowl, and a front grill. Side doors 7 are located at both sides of the cabin C. Each side door 7 opens and closes an entrance through which an occupant get in and out of the cabin C.

A dash panel 8 that separates the front space S1 from the cabin C is supported by the vehicle body frame 2. A dashboard 9 is located behind the dash panel 8 and in front of the occupant seat 6. The dashboard 9 faces the occupant seat 6 from a front side. The dashboard 9 includes meters. A steering wheel 10 opposed to the occupant seat 6 is located at the dashboard 9. An accommodating space S2 is defined between the dash panel 8 and the dashboard 9.

A cargo bed 11 is located behind the cabin frame 2b. The cargo bed 11 is open upward to the outside of the vehicle and defines a recessed loading space. An internal combustion engine 12 as a prime mover is located behind the occupant seat 6 and is supported by the vehicle body frame 2. At least part of the internal combustion engine 12 is located vertically under the cargo bed 11 in a vehicle side view. The internal combustion engine 12 is located behind a front end of the occupant seat 6. When the occupant seat 6 is slidable in the vehicle front-rear direction, the internal combustion engine 12 is located behind the front end of the occupant seat 6 in an entire slide region of the occupant seat 6.

A continuously variable transmission 13 is located adjacent to the internal combustion engine 12. The continuously variable transmission 13 changes the rotational speed of driving power output from the internal combustion engine 12. The driving power output from the continuously variable transmission 13 is transmitted to the front wheels 3 or the rear wheels 4 or to the front wheels 3 and the rear wheels 4. The internal combustion engine 12 is the prime mover for traveling. However, a combination of the internal combustion engine and an electric motor may be the prime mover, or only the electric motor may be the prime mover.

The off-road vehicle 1 includes an air conditioning system 20. An air conditioner 21 of the air conditioning system 20 is located in front of the dashboard 9. Specifically, the air conditioner 21 is located in the accommodating space S2 defined between the dash panel 8 and the dashboard 9. A condenser 25 of the air conditioning system 20 is located in the front space S1. A radiator 16 that cools the internal combustion engine 12 is located in the front space S1. An electric compressor 24 is located in front of the dash panel 8 and the dashboard 9. Specifically, the electric compressor 24 is located in the front space S1. The electric compressor 24 includes a cooling medium compressor and an electric motor that drives the cooling medium compressor.

A soundproof sheet 18 is attached to the dash panel 8. The soundproof sheet 18 suppresses the transmission of operation sound of the electric compressor 24 to the cabin C. The soundproof sheet 18 may be a sound insulator or a sound absorber. The sound insulator may be, for example, a lead sheet. The sound absorber may be, for example, a sheet including a large number of projections or a large number of holes. The soundproof sheet 18 may be attached to the front cover 5 or may be attached to the dashboard 9.

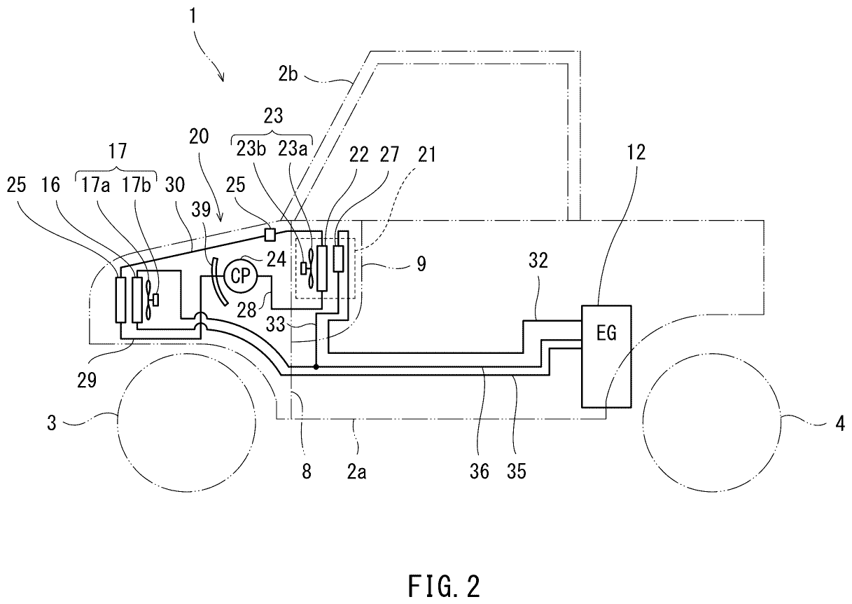

FIG. 2 is a left side view of the off-road vehicle 1 which shows pipes of the air conditioning system 20 and the like shown in FIG. 1. As shown in FIG. 2, for cooling of the cabin C, the air conditioning system 20 includes an evaporator 22, a blower 23, the electric compressor 24, the condenser 25, and an expansion valve 26. The air conditioner 21 located in the accommodating space S2 between the dash panel 8 and the dashboard 9 includes the evaporator 22 and the blower 23. The evaporator 22 evaporates a cooling medium to remove evaporation heat from surroundings. The blower 23 includes an air blow vane 23a and an electric motor 23b that drives the air blow vane 23a. The blower 23 generates air flow that makes air flow through the evaporator 22. Thus, the blower 23 sends cool air to the cabin C.

The evaporator 22 is in connection with the electric compressor 24 through a first cooling medium passage 28. The electric compressor 24 is located in front of the dashboard 9. Specifically, the electric compressor 24 is located in the front space S1. The electric compressor 24 is in connection with the condenser 25 through a second cooling medium passage 29. The condenser 25 performs heat exchange with outside air to lower the temperature of the cooling medium. The condenser 25 is in connection with the evaporator 22 through a third cooling medium passage 30.

The expansion valve 26 is located at the third cooling medium passage 30. The expansion valve 26 lowers the pressure and temperature of the cooling medium flowing from the condenser 25 toward the evaporator 22. The cooling medium which has reached the evaporator 22 from the expansion valve 26 is subjected to the heat exchange with the outside air at the evaporator 22 to evaporate. The first cooling medium passage 28, the second cooling medium passage 29, and the third cooling medium passage 30 are entirely located in front of the dashboard 9.

In the front space S1, the radiator 16 is located behind the condenser 25. The internal combustion engine 12 is in connection with the radiator 16 through a first cooling medium passage 35. The cooling medium which has been increased in temperature by the internal combustion engine 12 is sent to the radiator 16 through the first cooling medium passage 35. The radiator 16 is in connection with the internal combustion engine 12 through a second cooling medium passage 36. The cooling medium which has been reduced in temperature by the radiator 16 is sent to the internal combustion engine 12 through the second cooling medium passage 36.

A radiator fan 17 is located behind the radiator 16. The radiator fan 17 includes a fan vane 17a and an electric motor 17b that drives the fan vane 17a. The radiator fan 17 is located so as to send air toward a vehicle rear side. The outside air flows through the radiator 16 by the driving of the radiator fan 17, and thus, the radiator 16 is forcibly air-cooled. Since the condenser 25 is located so as to overlap the radiator 16 from the vehicle front side, the outside air flows through both of the condenser 25 and the radiator 16 by the driving of the radiator fan 17.

The electric compressor 24 is located behind the radiator fan 17. A fan air shield 39 is located between the radiator fan 17 and the electric compressor 24. The fan air shield 39 guides hot air, which flows from the radiator fan 17 toward the electric compressor 24, such that the hot air does not directly hit the electric compressor 24. For example, the fan air shield 39 may be an air guide plate that guides the hot air, which flows rearward from the radiator fan 17, to the lower side and the rear side.

For heating of the cabin C, the air conditioning system 20 includes a heater 27 included in the air conditioner 21. The heater 27 is in connection with the internal combustion engine 12 through a first heat medium passage 32. A heat medium which has been increased in temperature by the internal combustion engine 12 is sent to the heater 27 through the first heat medium passage 32. The heater 27 releases heat to surroundings. Since the air sent by the blower 23 flows through the heater 27, warm air is sent to the cabin C. The heater 27 is in connection with the second cooling medium passage 36 through a second heat medium passage 33. To be specific, the heat medium from the heater 27 and the cooling medium from the radiator 16 join together, flow through the second cooling medium passage 36, and reach the internal combustion engine 12.

The electric compressor 24 is located above the floor surface 19a (see FIG. 1) of the floor panel 19. Specifically, the electric compressor 24 is located above upper ends of the front wheels 3. The electric compressor 24 may be located above an upper end of a seat portion of the occupant seat 6 (see FIG. 1) which supports buttocks of the occupant from below.

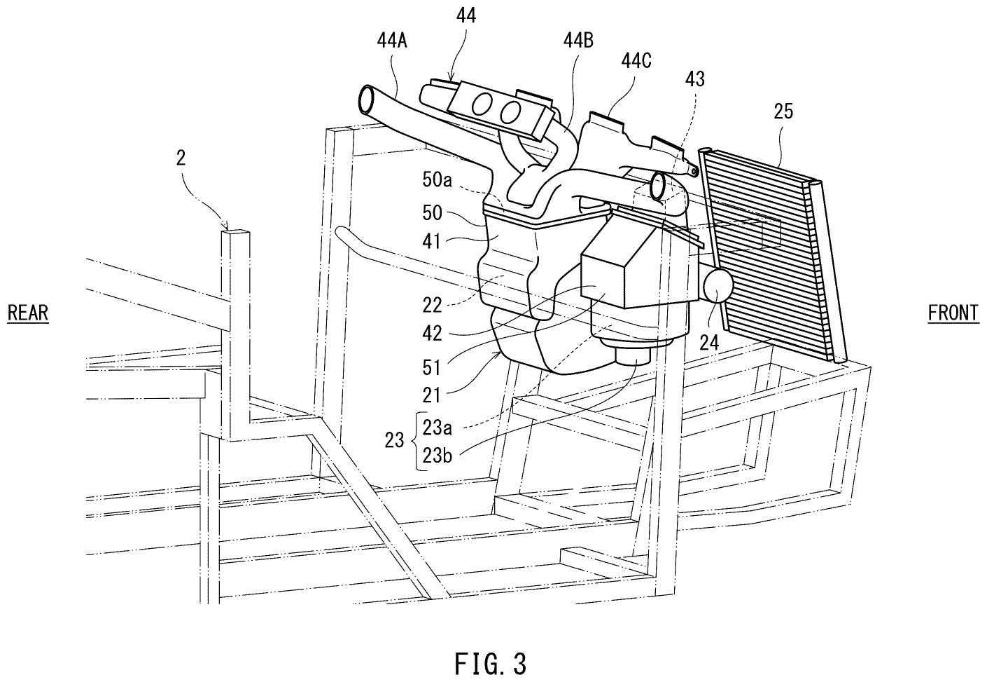

FIG. 3 is a perspective view when viewed from a rear-right side of the air conditioner 21 and the like of the vehicle of FIG. 1. As shown in FIG. 3, the air conditioner 21 includes a heat exchange segment 41, an air blow segment 42, an intake duct 43, and a discharge duct 44. A cooling medium inlet of the heat exchange segment 41 is in connection with the condenser 25. A cooling medium outlet of the heat exchange segment 41 is in connection with the electric compressor 24.

The heat exchange segment 41 includes a housing 50 and the evaporator 22 accommodated in the housing 50. An upper wall of the housing 50 includes an outlet 50a through which the air which has been cooled by the evaporator 22 flows out. The discharge duct 44 is fixed to the housing 50 and communicates with the outlet 50a. The air which has flowed out from the outlet 50a flows through the discharge duct 44.

Specifically, the discharge duct 44 includes first discharge ducts 44A, a second discharge duct 44B, and third discharge ducts 44C. The first discharge ducts 44A include discharge ports which are directed to the cabin C through openings of both side portions of the dashboard 9 (see FIG. 1) in the vehicle left-right direction. The second discharge duct 44B includes a discharge port which is directed to the cabin C through an opening of a middle portion of the dashboard 9 in the vehicle left-right direction. The third discharge ducts 44C include discharge ports which are directed to a windshield through openings of a front portion of the dashboard 9. The windshield covers the cabin C from the front side.

The air blow segment 42 includes a housing 51, the air blow vane 23a accommodated in the housing 51, and the electric motor 23b that drives the air blow vane 23a. An internal space of the housing 51 of the air blow segment 42 communicates with an internal space of the housing 50 of the heat exchange segment 41. The air blow segment 42 takes the air from the outside of the vehicle into the housing 51 through the intake duct 43 by the rotation of the air blow vane 23a driven by the electric motor 23b, sends the air into the heat exchange segment 41, and makes the air flow through the evaporator 22.

The electric compressor 24 is located in front of the air conditioner 21. The dash panel 8 which is not shown in FIG. 3 is located between the air conditioner 21 and the electric compressor 24. The electric compressor 24 is located between the air conditioner 21 and the condenser 25 in the vehicle front-rear direction.

According to the above-described configuration, since all of the air conditioner 21, the condenser 25, the expansion valve 26, and the electric compressor 24 are located in front of the dashboard 9, the first cooling medium passage 28 that connects the evaporator 22 to the electric compressor 24 and the second cooling medium passage 29 that connects the electric compressor 24 to the condenser 25 can be made short. Therefore, the air conditioning system 20 mounted on the off-road vehicle 1 can be reduced in size as a whole. Moreover, since the compressor 24 is of an electric type, the air conditioning system 20 can exert adequate cooling ability even during low-speed traveling.

Since the air conditioning system 20 is entirely located in a region located in front of the dashboard 9, the air conditioning system 20 mounted on the off-road vehicle 1 can be reduced in size as a whole. Since the electric compressor 24 is located at a place adequately away from the internal combustion engine 12, the influence of the vibration and heat of the internal combustion engine 12 on the electric compressor 24 can be reduced.

Since the electric compressor 24 is located in the front space S1, the accommodating space S2 between the dash panel 8 and the dashboard 9 is located between the occupant in the cabin C and the electric compressor 24. Therefore, the operation sound of the electric compressor 24 which is transmitted to the occupant can be reduced. Moreover, since the electric compressor 24 is located in the front space S1 together with the radiator fan 17, the operation sound of the electric compressor 24 gets mixed with the operation sound of the radiator fan 17, and this can prevent the occupant from feeling unpleasant.

The fan air shield 39 prevents the hot air, which has been sent from the radiator fan 17, from directly hitting the electric compressor 24, and this can suppress an increase in the temperature of the electric compressor 24. Moreover, the electric compressor 24 is located at a high position in the front space S1. Therefore, it is possible to reduce a possibility that when the off-road vehicle 1 travels in a puddle, water is splashed onto the electric compressor 24.

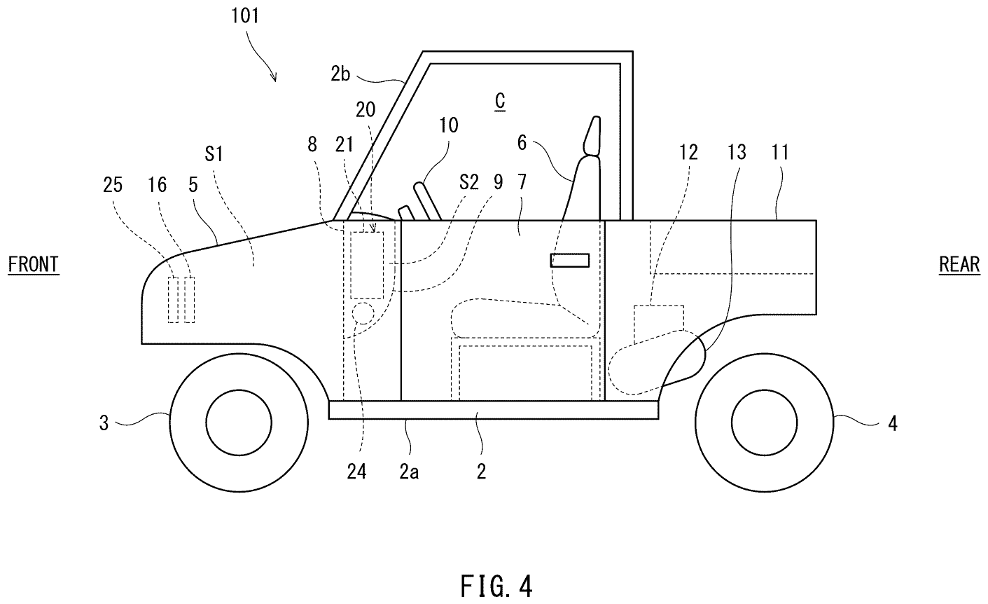

FIG. 4 is a left side view of an off-road vehicle 101 which shows Modified Example 1 of the position of the electric compressor 24. As shown in FIG. 4, in the off-road vehicle 101, the electric compressor 24 is located in the accommodating space S2 between the dash panel 8 and the dashboard 9 together with the air conditioner 21. The electric compressor 24 is located under the air conditioner 21. According to this, since the electric compressor 24 is not located in the front space S1, the degree of freedom of the positions of the parts located in the front space S1 can be improved.

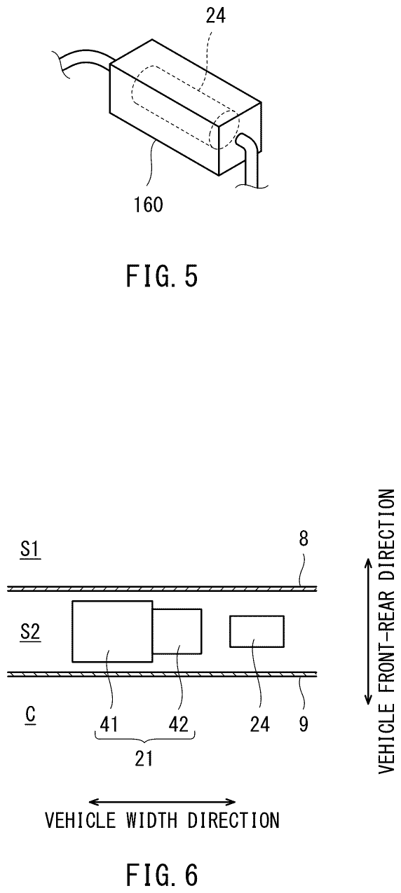

FIG. 5 is a perspective view of the electric compressor 24 of FIG. 4 and a soundproof structure 160. As shown in FIG. 5, the electric compressor 24 may be covered with the soundproof structure 160. The soundproof structure 160 may be, for example, a sound absorbing box including a surface which is opposed to the electric compressor 24 and includes a large number of projections. The soundproof structure 160 may be a sound insulator that covers the electric compressor 24. The soundproof structure 160 may be applied to the electric compressor 24 located in the accommodating space S2 or may be applied to the electric compressor 24 located in the front space S1.

FIG. 6 is a plan view showing Modified Example 2 of the position of the electric compressor 24. As shown in FIG. 6, when the electric compressor 24 is located in the accommodating space S2 defined between the dash panel 8 and the dashboard 9, the electric compressor 24 may be located so as to be lined up with the air conditioner 21 in the vehicle width direction. The electric compressor 24 may be located at such a height as to overlap the air conditioner 21 when viewed in the vehicle width direction.

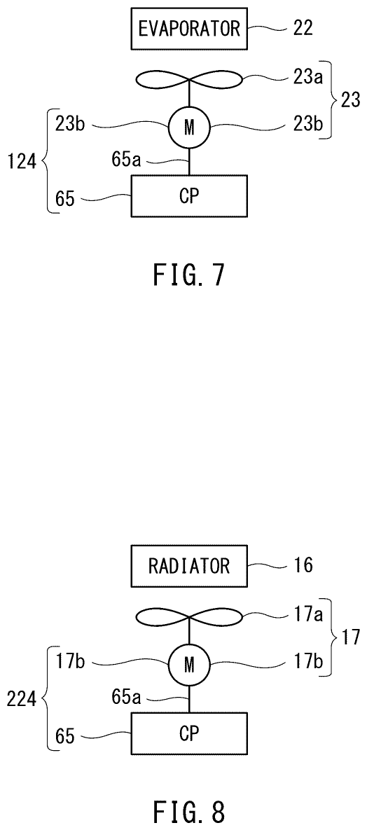

FIG. 7 is a schematic diagram showing an electric compressor 124 of Modified Example 1. As shown in FIG. 7, the electric compressor 124 includes a cooling medium compressor 65 including a driven shaft 65a. The driven shaft 65a of the cooling medium compressor 65 is in connection with the electric motor 23b of the blower 23. The electric motor 23b is in connection with the air blow vane 23a and the driven shaft 65a of the cooling medium compressor 65 so as to be used for both of the driving of the air blow vane 23a and the driving of the cooling medium compressor 65. To be specific, the cooling medium compressor 65 and the electric motor 23b constitute the electric compressor 124.

FIG. 8 is a schematic diagram showing an electric compressor 224 of Modified Example 2. As shown in FIG. 8, the driven shaft 65a of the cooling medium compressor 65 is in connection with the electric motor 17b of the radiator fan 17. The electric motor 17b is in connection with the fan vane 17a and the driven shaft 65a of the cooling medium compressor 65 so as to be used for both of the driving of the fan vane 17a and the driving of the cooling medium compressor 65. To be specific, the cooling medium compressor 65 and the electric motor 17b constitute the electric compressor 124.

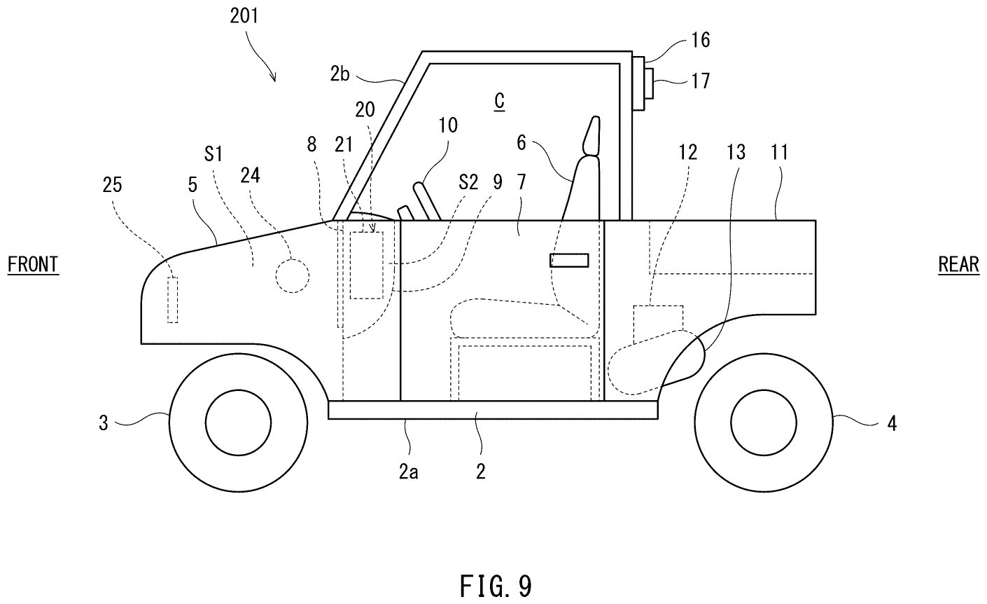

FIG. 9 is a left side view of an off-road vehicle 301 which shows Modified Example 1 of the position of the radiator 16. As shown in FIG. 9, in the off-road vehicle 301, the radiator 16 connected to the internal combustion engine 12 is located behind the cabin C. Specifically, the radiator 16 is fixed to a rear portion of the cabin frame 2b. According to this, since the electric compressor 24 is located at a place adequately away from the radiator 16, the influence of the heat of the radiator 16 on the electric compressor 24 is reduced. Moreover, the cooling medium passage that connects the radiator 16 and the internal combustion engine 12 is made short. The radiator 16 may be located under the cargo bed 11.

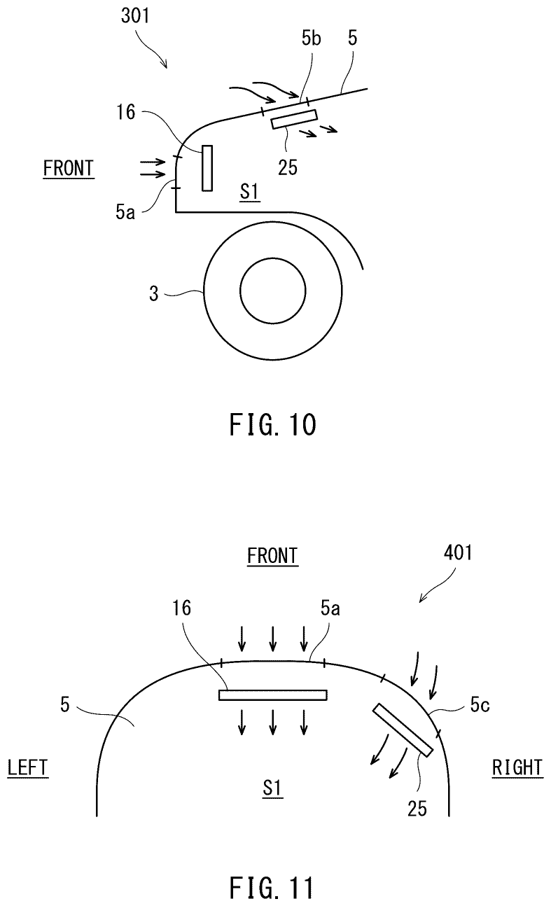

FIG. 10 is a left side view of major components of the off-road vehicle 301 which shows Modified Example 1 of the position of the condenser 25. As shown in FIG. 10, in the off-road vehicle 301, the condenser 25 is located outside the radiator 16 in a direction orthogonal to the vehicle front-rear direction. Specifically, the condenser 25 is located behind and above the radiator 16. The condenser 25 is located along an inner surface of the front cover 5. The front cover 5 includes: an opening 5a that guides the traveling wind to the radiator 16; and an opening 5b that guides the traveling wind to the condenser 25. According to this configuration, the influence between the condenser 25 and the radiator 16 is reduced, and both of the radiator 16 and the condenser 25 can be suitably air-cooled.

FIG. 11 is a plan view of major components of an off-road vehicle 401 which shows Modified Example 2 of the position of the condenser 25. As shown in FIG. 11, in the off-road vehicle 401, the condenser 25 is located outside the radiator 16 in a direction orthogonal to the vehicle front-rear direction. Specifically, the condenser 25 is located outside the radiator 16 in the vehicle width direction. The condenser 25 is located along the inner surface of the front cover 5. The front cover 5 includes: the opening 5a that guides the traveling wind to the radiator 16; and an opening 5c that guides the traveling wind to the condenser 25. According to this configuration, the influence between the condenser 25 and the radiator 16 is reduced, and both of the radiator 16 and the condenser 25 can be suitably air-cooled.

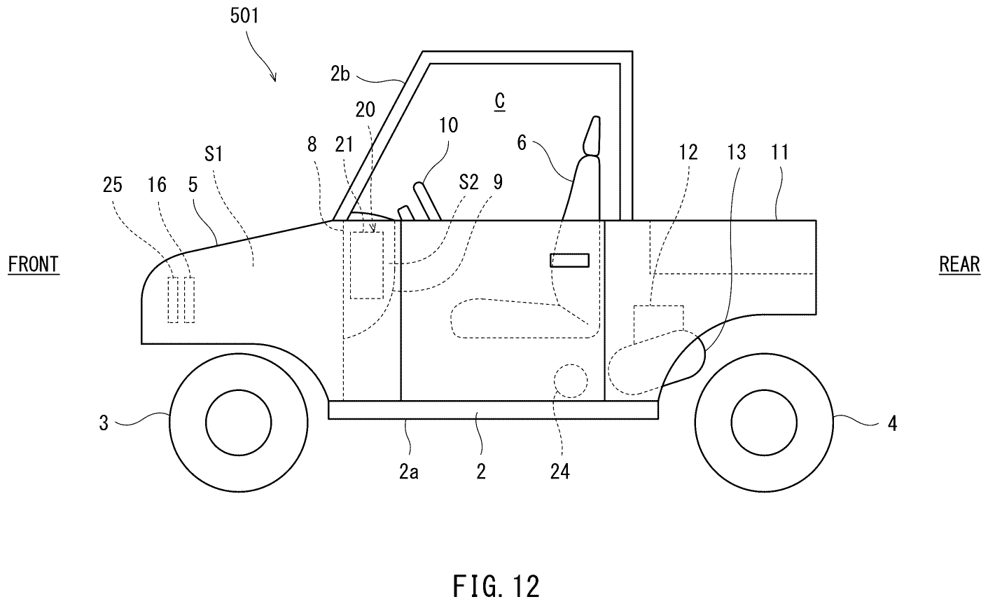

FIG. 12 is a left side view of an off-road vehicle 501 which shows a modified example of the position of the compressor. As shown in FIG. 12, at least part of the internal combustion engine 12 is located vertically under the cargo bed 11 in the vehicle side view. At least part of the electric compressor 24 is located vertically under the occupant seat 6 in the vehicle side view. When the occupant seat 6 is slidable in the vehicle front-rear direction, at least part of the electric compressor 24 is located vertically under the occupant seat 6 in the entire slide region of the occupant seat 6 in the vehicle side view. The electric compressor 24 is located in front of the internal combustion engine 12.

According to this configuration, since the electric compressor 24 is located away from the internal combustion engine 12 in the vehicle side view, the influence of the internal combustion engine 12 on the electric compressor 24 can be reduced. Moreover, since the compressor 24 is of an electric type, the degree of freedom of the position of the compressor 24 in the space under the occupant seat 6 can be improved.

### ASPECTS

The above-described embodiment is a specific example of the following aspects.

### First Aspect

An off-road vehicle including:
a cabin in which an occupant seat is located;
a front cover that defines a front space from above, the front space being located in front of the cabin;
a dash panel that separates the cabin from the front space;
a dashboard that is located behind the dash panel and faces the occupant seat; and
an air conditioning system, wherein
the air conditioning system includes
   an air conditioner that is located in front of the dashboard and includes an evaporator and a blower,
   a condenser located in the front space, and
   an electric compressor located in front of the dashboard.

According to this configuration, since all of the air conditioner, the condenser, and the electric compressor are located in front of the dashboard, a cooling medium passage that connects the evaporator to the electric compressor and a cooling medium passage that connects the electric compressor to the condenser can be made short. Therefore, the air conditioning system mounted on the off-road vehicle can be reduced in size as a whole. Moreover, since the compressor is of an electric type, the air conditioning system can exert adequate cooling ability even during low-speed traveling.

### Second Aspect

The off-road vehicle according to the first aspect, further including:
a first cooling medium passage that connects the evaporator to the electric compressor; and
a second cooling medium passage that connects the electric compressor to the evaporator, wherein
the first cooling medium passage and the second cooling medium passage are entirely located in front of the dashboard.

According to this configuration, since the air conditioning system is entirely located in a region located in front of the dashboard, the air conditioning system mounted on the off-road vehicle can be reduced in size as a whole.

### Third Aspect

The off-road vehicle according to the first or second aspect, further including a prime mover located behind a front end of the occupant seat.

According to this configuration, since the electric compressor is located at a place adequately away from the prime mover, the influence of the prime mover on the electric compressor can be reduced.

### Fourth Aspect

The off-road vehicle according to the third aspect, wherein the prime mover includes an internal combustion engine.

According to this configuration, since the electric compressor is located at a place adequately away from the internal combustion engine, the influence of the vibration and heat of the internal combustion engine on the electric compressor can be reduced.

### Fifth Aspect

The off-road vehicle according to any one of the first to fourth aspects, wherein:
the air conditioner is located in an accommodating space between the dash panel and the dashboard; and
the electric compressor is located in the front space.

According to this configuration, since the accommodating space between the dash panel and the dashboard is located between the occupant in the cabin and the electric compressor, the operation sound of the electric compressor which is transmitted to the occupant can be reduced.

### Sixth Aspect

The off-road vehicle according to any one of the first to fifth aspects, further including:
a radiator located in the front space; and
a radiator fan located behind the radiator, wherein
the electric compressor is located in the front space together with the radiator fan.

According to this configuration, since the operation sound of the electric compressor gets mixed with the operation sound of the radiator fan, the occupant can be prevented from feeling unpleasant.

### Seventh Aspect

The off-road vehicle according to the sixth aspect, further including a fan air shield located in the front space, wherein:
the radiator fan is located so as to send air toward a vehicle rear side;
the electric compressor is located behind the radiator fan; and
the fan air shield is located between the radiator fan and the electric compressor.

According to this configuration, the fan air shield prevents the hot air, which has been sent from the radiator fan, from directly hitting the electric compressor, and this can suppress an increase in the temperature of the electric compressor.

### Eighth Aspect

The off-road vehicle according to any one of the first to seventh aspects, further including a soundproof structure covering the electric compressor.

According to this configuration, since the operation sound of the electric compressor is blocked by the soundproof structure, the operation sound of the electric compressor which is transmitted to the occupant can be reduced.

### Ninth Aspect

The off-road vehicle according to any one of the first to eighth aspects, further including a soundproof sheet attached to at least one selected from the group consisting of the front cover, the dash panel, and the dashboard.

According to this configuration, since the operation sound of the electric compressor is blocked by the soundproof sheet, the operation sound of the electric compressor which is transmitted to the occupant can be reduced.

### Tenth Aspect

The off-road vehicle according to any one of the first to ninth aspects, further including:
a vehicle body frame including a floor frame; and
a floor panel that is located at an upper side of the floor frame, defines the cabin from below, and includes a floor surface located in front of and under the occupant seat, wherein
the electric compressor is located above the floor surface.

According to this configuration, it is possible to reduce a possibility that when the off-road vehicle travels in a puddle, water is splashed onto the electric compressor.

### Eleventh Aspect

The off-road vehicle according to any one of the first to tenth aspects, further including:
a vehicle body frame; and
a front wheel supporting the vehicle body frame, wherein
the electric compressor is located above an upper end of the front wheel.

According to this configuration, it is possible to reduce a possibility that when the off-road vehicle travels in a puddle, water is splashed onto the electric compressor.

### Twelfth Aspect

The off-road vehicle according to any one of the first to eleventh aspects, wherein the air conditioner and the electric compressor are located in an accommodating space between the dash panel and the dashboard.

According to this configuration, the degree of freedom of the positions of the parts located in the front space can be improved.

### Thirteenth Aspect

The off-road vehicle according to any one of the first to twelfth aspects, further including:
a radiator located in the front space;
a radiator fan located behind the radiator; and
an electric motor, wherein:
the radiator fan includes a fan vane;
the blower of the air conditioner includes an air blow vane;
the electric compressor includes a cooling medium compressor including a driven shaft; and
the electric motor is in connection with the fan vane or the air blow vane and is in connection with the cooling medium compressor so as to be used for both of driving of the fan vane or the air blow vane and driving of the cooling medium compressor.

According to this configuration, since the electric compressor shares the electric motor with the radiator fan or the blower, the number of parts can be reduced.

### Fourteenth Aspect

The off-road vehicle according to any one of the first to thirteenth aspects, further including:
an internal combustion engine located behind a front end of the occupant seat;
a radiator located behind the cabin; and
a cooling medium passage that connects the radiator to the internal combustion engine.

According to this configuration, since the electric compressor is located at a place adequately away from the radiator, the influence of the heat of the radiator on the electric compressor can be reduced. Moreover, the cooling medium passage that connects the radiator and the internal combustion engine can be made short.

### Fifteenth Aspect

The off-road vehicle according to any one of the first to fourteenth aspects, further including a radiator located in the front space, wherein
the condenser is located outside the radiator in a direction orthogonal to a vehicle front-rear direction.

According to this configuration, the influence between the electric compressor and the radiator can be reduced.

### Sixteenth Aspect

An off-road vehicle including:
a vehicle body frame;
a cabin in which an occupant seat supported the vehicle body frame is located;
a cargo bed located behind the cabin and supported by the vehicle body frame;
a prime mover supported by the vehicle body frame; and
an air conditioning system including a compressor, wherein:
at least part of the prime mover is located vertically under the cargo bed in a vehicle side view; and
at least part of the compressor is located vertically under the occupant seat and in front of the prime mover in the vehicle side view.

According to this configuration, since the compressor is located away from the prime mover in the vehicle side view, the influence of the prime mover on the compressor can be reduced.

### Seventeenth Aspect

The off-road vehicle according to the sixteenth aspect, wherein the compressor includes an electric compressor.

According to this configuration, the degree of freedom of the position of the compressor can be improved.

What is claimed is:

1. An off-road vehicle comprising:
a cabin in which an occupant seat is located;
a front cover that defines a front space from above, the front space being located in front of the cabin;
a dash panel that separates the cabin from the front space;
a dashboard that is located behind the dash panel and faces the occupant seat; and
an air conditioning system, wherein
the air conditioning system includes
an air conditioner that is located in front of the dashboard and includes an evaporator and a blower,
a condenser located in the front space, and
an electric compressor located in front of the dashboard.

2. The off-road vehicle according to claim 1, further comprising:
a first cooling medium passage that connects the evaporator to the electric compressor; and
a second cooling medium passage that connects the electric compressor to the evaporator, wherein
the first cooling medium passage and the second cooling medium passage are entirely located in front of the dashboard.

3. The off-road vehicle according to claim 1, further comprising a prime mover located behind a front end of the occupant seat.

4. The off-road vehicle according to claim 3, wherein the prime mover includes an internal combustion engine.

5. The off-road vehicle according to claim 1, wherein:
the air conditioner is located in an accommodating space between the dash panel and the dashboard; and
the electric compressor is located in the front space.

6. The off-road vehicle according to claim 1, further comprising:
a radiator located in the front space; and
a radiator fan located behind the radiator, wherein
the electric compressor is located in the front space together with the radiator fan.

7. The off-road vehicle according to claim 6, further comprising a fan air shield located in the front space, wherein:
the radiator fan is located so as to send air toward a vehicle rear side;
the electric compressor is located behind the radiator fan; and
the fan air shield is located between the radiator fan and the electric compressor.

8. The off-road vehicle according to claim 1, further comprising a soundproof structure covering the electric compressor.

9. The off-road vehicle according to claim 1, further comprising a soundproof sheet attached to at least one selected from the group consisting of the front cover, the dash panel, and the dashboard.

10. The off-road vehicle according to claim 1, further comprising:
a vehicle body frame including a floor frame; and
a floor panel that is located at an upper side of the floor frame, defines the cabin from below, and includes a floor surface located in front of and under the occupant seat, wherein
the electric compressor is located above the floor surface.

11. The off-road vehicle according to claim 1, further comprising:
a vehicle body frame; and
a front wheel supporting the vehicle body frame, wherein
the electric compressor is located above an upper end of the front wheel.

12. The off-road vehicle according to claim 1, wherein the air conditioner and the electric compressor are located in an accommodating space between the dash panel and the dashboard.

13. The off-road vehicle according to claim 1, further comprising:
a radiator located in the front space;
a radiator fan located behind the radiator; and
an electric motor, wherein:
the radiator fan includes a fan vane;
the blower of the air conditioner includes an air blow vane;
the electric compressor includes a cooling medium compressor including a driven shaft; and
the electric motor is in connection with the fan vane or the air blow vane and is in connection with the cooling medium compressor so as to be used for both of driving of the fan vane or the air blow vane and driving of the cooling medium compressor.

14. The off-road vehicle according to claim 1, further comprising:
an internal combustion engine located behind a front end of the occupant seat;
a radiator located behind the cabin; and
a cooling medium passage that connects the radiator to the internal combustion engine.

15. The off-road vehicle according to claim 1, further comprising a radiator located in the front space, wherein
the condenser is located outside the radiator in a direction orthogonal to a vehicle front-rear direction.

16. An off-road vehicle comprising:
a vehicle body frame;
a cabin in which an occupant seat supported the vehicle body frame is located;
a cargo bed located behind the cabin and supported by the vehicle body frame;
a prime mover supported by the vehicle body frame; and
an air conditioning system including a compressor, wherein:
at least part of the prime mover is located vertically under the cargo bed in a vehicle side view; and
at least part of the compressor is located vertically under the occupant seat and in front of the prime mover in the vehicle side view.

17. The off-road vehicle according to claim 16, wherein the compressor includes an electric compressor.
